(19) United States
(12) Patent Application Publication
(10) Pub. No.: US 2025/0362409 A1
(43) Pub. Date: Nov. 27, 2025

(54) Apparatus for Controlling Vehicle and Method Thereof

(71) Applicants: Hyundai Motor Company, Seoul (KR); Kia Corporation, Seoul (KR)

(72) Inventor: Ju Heon Baeg, Hwaseong-si (KR)

(21) Appl. No.: 18/964,001

(22) Filed: Nov. 29, 2024

(30) Foreign Application Priority Data
May 24, 2024 (KR) 10-2024-0068046

(51) Int. Cl. G01S 17/42; B60W 60/00; G01S 17/931

(52) U.S. Cl. CPC G01S 17/42; B60W 60/001; G01S 17/931

(57) ABSTRACT

An apparatus for controlling autonomous driving of a vehicle is introduced. The apparatus may comprise a sensor to obtain a cluster points representing an object and a processor to generate a first virtual box corresponding to the object based on sensor data. The processor may further obtain a heading confidence value for the heading direction of the first virtual box by applying a loss function associated with a designated algorithm. This loss function indicates the algorithm's accuracy in determining the heading direction. Based on the heading confidence value, the processor may derive an angle value to adjust the heading direction, resulting in a second virtual box with the adjusted heading. A signal is generated indicating the second virtual box, and this signal may be used to control the autonomous driving of the vehicle.

### CROSS-REFERENCE TO RELATED APPLICATION

This application claims the benefit of priority to Korean Patent Application No. 10-2024-0068046, filed in the Korean Intellectual Property Office on May 24, 2024, the entire contents of which are incorporated herein by reference.

### TECHNICAL FIELD

The present disclosure relates to a vehicle control apparatus and a method thereof, and more particularly, relates to a technology for using a sensor (e.g., light detection and ranging (LiDAR)).

### BACKGROUND

The matters described in this Background section are only for enhancement of understanding of the background of the disclosure, and should not be taken as acknowledgement that they correspond to prior art already known to those skilled in the art.

Various studies are being conducted to identify or determine an external object by using various sensors to assist the driving of a vehicle.

In particular, while operating in a driving assistance mode or an autonomous driving mode, the vehicle may identify or determine the external object by using a sensor (e.g., LiDAR).

If the vehicle identifies the external object through the LiDAR, the heading direction of a virtual box, which indicates the traveling direction of the external object identified by the LiDAR, may be incorrectly identified. Accordingly, various studies are being conducted to solve the issues.

### SUMMARY

According to the present disclosure, an apparatus for controlling autonomous driving of a vehicle, the apparatus may comprise a sensor configured to obtain a cluster of points, wherein the cluster of points corresponds to an object, and a processor configured to generate, based on information from the sensor, a first virtual box, wherein the first virtual box corresponds to the object, obtain, based on a loss function associated with the first virtual box, a heading confidence value for a heading direction of the first virtual box, wherein the loss function is obtained by applying a designated algorithm to the first virtual box, wherein the loss function represents a degree of accuracy of the designated algorithm for determining the heading direction, and wherein the heading confidence value represents a level of confidence that the object is moving in the heading direction as indicated, obtain, based on the heading confidence value, an angle value for adjusting the heading direction, output, based on adjusting the heading direction of the first virtual box, a second virtual box, wherein the heading direction is adjusted based on the angle value, generate a signal indicating the second virtual box, and control, based on the signal, autonomous driving of the vehicle.

The processor may be configured to obtain, based on a peak of the loss function and a valley of the loss function, the heading confidence value.

The processor may be configured to obtain the heading confidence value based on a median value and a difference value, wherein the median value is obtained by dividing a sum of a first value and a second value by two, wherein the first value is associated with the peak of the loss function, wherein the second value is associated with the valley of the loss function, and wherein the difference value is obtained by dividing a difference between the first value and the second value by two.

The processor may be configured to determine the heading confidence value by dividing the difference value by the median value.

The processor may be configured to generate the second virtual box, wherein the second virtual box is obtained by adjusting the first virtual box based on a width of the first virtual box being smaller than a first length and a length of the first virtual box being smaller than a second length.

The processor may be configured to obtain, based on applying the heading confidence value to the heading direction of the first virtual box, the angle value.

The processor may be configured to obtain the angle value based on applying a coefficient to the heading direction, wherein the coefficient is obtained by multiplying the heading confidence value by the heading confidence value.

The processor may be configured to determine a number of times of the multiplying based on at least one of the heading confidence value, a size of the first virtual box, a distance between the object and the vehicle, or a number of points in the cluster of points.

The processor may be configured to generate the second virtual box with a second heading direction, wherein the second heading direction indicates a difference in the angle value based on a longitudinal axis of the vehicle in a vehicle coordinate system, and wherein the vehicle coordinate system is centered on the vehicle.

The processor may be configured to generate the second virtual box, wherein the second virtual box is obtained by adjusting the first virtual box based on a maximum value of a vertical axis direction of the object, a minimum value of the vertical axis direction, and the angle value among coordinate values of points in the cluster of points.

According to the present disclosure, a method performed by an apparatus for controlling autonomous driving of a vehicle, the method may comprise generating, based on information from a sensor, a first virtual box, wherein the first virtual box corresponds to an object, and wherein a cluster of points, corresponding to the object, are obtained by the sensor, obtaining, based on a loss function associated with the first virtual box, a heading confidence value for a heading direction of the first virtual box, wherein the loss function is obtained by applying a designated algorithm to the first virtual box, wherein the loss function represents a degree of accuracy of the designated algorithm for determining the heading direction, and wherein the heading confidence value represents a level of confidence that the object is moving in the heading direction as indicated, obtaining, based on the heading confidence value, an angle value for adjusting the heading direction, outputting, based on adjusting the heading direction of the first virtual box, a second virtual box, wherein the heading direction is adjusted based on the angle value, generating a signal indicating the second virtual box, and controlling, based on the signal, autonomous driving of the vehicle.

The method may further comprise obtaining, based on a peak of the loss function and a valley of the loss function, the heading confidence value.

The method may further comprise obtaining the heading confidence value based on a median value and a difference value, wherein the median value is obtained by dividing a sum of a first value and a second value by two, wherein the first value is associated with the peak of the loss function, wherein the second value is associated with the valley of the loss function, and wherein the difference value is obtained by dividing a difference between the first value and the second value by two.

The method may further comprise determining the heading confidence value by dividing the difference value by the median value.

The method may further comprise generating the second virtual box, wherein the second virtual box is obtained by adjusting the first virtual box based on a width of the first virtual box being smaller than a first length and a length of the first virtual box being smaller than a second length.

The method may further comprise obtaining, based on applying the heading confidence value to the heading direction of the first virtual box, the angle value.

The method may further comprise obtaining the angle value based on applying a coefficient to the heading direction, wherein the coefficient is obtained by multiplying the heading confidence value by the heading confidence value.

The method may further comprise determining a number of times of the multiplying based on at least one of the heading confidence value, a size of the first virtual box, a distance between the object and the vehicle, or a number of points in the cluster of points.

The method may further comprise generating the second virtual box with a second heading direction, wherein the second heading direction indicates a difference in the angle value based on a longitudinal axis of the vehicle in a vehicle coordinate system, and wherein the vehicle coordinate system is centered on the vehicle.

The method may further comprise generating the second virtual box, wherein the second virtual box is obtained by adjusting the first virtual box based on a maximum value of a vertical axis direction of the object, a minimum value of the vertical axis direction, and the angle value among coordinate values of points in the cluster of points.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram associated with a vehicle control apparatus, according to an example of the present disclosure;

FIG. 2 shows an example of a flowchart associated with a vehicle control method, according to an example of the present disclosure;

FIG. 3 shows an example of generating a virtual box, in an example of the present disclosure;

FIG. 4 shows an example of obtaining an angle for correcting or adjusting a virtual box by using a loss function, in an example of the present disclosure;

FIG. 5 shows an example associated with an angle for correcting or adjusting a heading direction of a first virtual box, in an example of the present disclosure;

FIG. 6 shows an example of generating a second virtual box by correcting or adjusting a heading direction of a first virtual box, in an example of the present disclosure;

FIG. 7 shows an example of a flowchart associated with a vehicle control method, according to an example of the present disclosure; and

FIG. 8 shows an example of a computing system associated with a vehicle control apparatus or vehicle control method, according to an example of the present disclosure.

### DETAILED DESCRIPTION

Hereinafter, some examples of the present disclosure will be described in detail with reference to the accompanying drawings. In adding reference numerals to components of each drawing, it should be noted that the same components include the same reference numerals, although they are indicated on another drawing. Furthermore, in describing the examples of the present disclosure, detailed descriptions associated with well-known functions or configurations will be omitted if they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A: (2) at least one B; or (3) at least one A and at least one B.

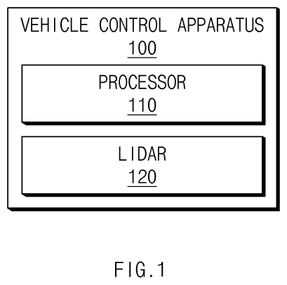

Hereinafter, examples of the present disclosure will be described in detail with reference to FIGS. 1 to 8.

FIG. 1 shows an example of a block diagram associated with a vehicle control apparatus, according to an example of the present disclosure.

Referring to FIG. 1, a vehicle control apparatus 100 according to an example of the present disclosure may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be coupled with control units of the vehicle by means of a separate connection means. For example, the vehicle control apparatus 100 may further include components not shown in FIG. 1.

The vehicle control apparatus 100 according to an example may include a processor 110 and a LiDAR 120. The processor 110 and the LiDAR 120 may be electronically and/or operably coupled with each other by an electronical component including a communication bus.

Hereinafter, the fact that pieces of hardware are coupled operably may include the fact that a direct and/or indirect connection between the pieces of hardware is established by wired and/or wirelessly such that second hardware is controlled by first hardware among the pieces of hardware.

Although different blocks are shown, an example is not limited thereto. Some of the pieces of hardware in FIG. 1 may be included in a single integrated circuit including a system on a chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an example may include hardware for processing data based on one or more instructions. The hardware for processing data may include the processor 110.

For example, the hardware for processing data may include an arithmetic and logic unit (ALU), a floating point unit (FPU), a field programmable gate array (FPGA), a central processing unit (CPU), and/or an application processor (AP). The processor 110 may include a structure of a single-core processor, or may include a structure of a multi-core processor including a dual core, a quad core, a hexa core, or an octa core.

The LiDAR 120 of the vehicle control apparatus 100 according to an example may obtain data sets obtained by identifying or determining objects surrounding the vehicle control apparatus 100 (or a vehicle including the vehicle control apparatus 100). For example, the LiDAR 120 may identify or determine at least one of a location of the surrounding object, a movement direction of the surrounding object, or the speed of the surrounding object, or any combination thereof based on a pulse laser signal emitted from the LiDAR 120 being reflected and returned by the surrounding object.

The processor 110 of the vehicle control apparatus 100 according to an example may obtain a cluster of points (e.g., a point cloud) corresponding to an external object through the LIDAR 120. For example, the processor 110 may obtain the point cloud corresponding to the external object based on a pulse laser signal, which is obtained through the LiDAR 120 and which is reflected by the external object. For example, the point cloud may comprise a collection of data points in a three-dimensional coordinate system, representing the external surface of an object or environment. Each point in the cloud may have its own set of X, Y, and Z coordinates, and/or additional information (e.g., color or intensity). The point clouds may be generated by 3D scanners, LiDAR, or photogrammetry techniques, and may be used in various applications such as 3D modeling, computer vision, and/or robotics, etc. They may provide a highly detailed and/or accurate representation of complex surfaces and/or structures, making them ideal for tasks like object recognition, environment mapping, and/or digital reconstruction, etc.

For example, the processor 110 may generate a first virtual box corresponding to the external object based on obtaining the point cloud corresponding to the external object through the LiDAR 120. For example, the first virtual box may include a virtual box representing the external object in a three-dimensional spatial coordinate system. In the context of autonomous driving, virtual boxes may refer to bounding boxes 5 or virtual representations that are used to define the approximate space occupied by external objects detected by the vehicle's sensors (such as cameras, LiDAR, or radar). These virtual boxes may be aligned with a 3D coordinate system (e.g., x, y, and z axes) and may be projected around objects in the environment, such as pedestrians, other vehicles, cyclists, or obstacles, to help the autonomous system understand their positions, sizes, and movement. The autonomous system may use these boxes to track the movement of objects over time, allowing it to predict their future trajectories. This tracking capability may be applied for collision avoidance, as the system may determine distances and evaluate potential risks of collisions, enabling it to take actions like braking or steering to avoid obstacles. Further, virtual boxes may provide useful spatial information for path planning, helping the vehicle adjust its route to maintain safe distances from surrounding objects and navigate through complex environments. The virtual boxes may provide a simplified geometric representation of real-world objects, allowing the autonomous driving system to process and respond to its surroundings efficiently.

In an example, the processor 110 may apply a designated algorithm to a first virtual box. For example, the processor 110 may obtain a loss function based on applying the designated algorithm to the first virtual box. For example, the processor 110 may obtain heading confidence for the first virtual box based on the loss function obtained by applying the designated algorithm to the first virtual box.

In machine learning, a loss function (also may referred to as a cost function or error function) is a method of evaluating how well a specific algorithm models the given data. By comparing the predicted values generated by the model to the actual target values, the loss function quantifies the error or difference. The purpose of the loss function is to guide the training process. When the model makes a prediction, the loss function computes a numerical value representing how far the prediction is from the true value. The goal of the learning algorithm is to minimize this loss value by adjusting the model's parameters during the training phase.

For example, the heading confidence for the first virtual box may include a value expressing the confidence of the heading direction indicating a direction in which the external object corresponding to the first virtual box is moving.

For example, the processor 110 may obtain a maximum value corresponding to a peak of the amplitude of the loss function. For example, the processor 110 may obtain a minimum value corresponding to a valley of the amplitude of the loss function.

For example, the processor 110 may obtain the heading confidence for the first virtual box based on the maximum value corresponding to the peak of the amplitude of the loss function and the minimum value corresponding to the valley of the amplitude of the loss function.

For example, the processor 110 may obtain a median value obtained by dividing the sum of the maximum value corresponding to the peak of the amplitude of the loss function and the minimum value corresponding to the valley of the amplitude of the loss function by 2.

For example, the processor 110 may obtain a difference value obtained by dividing a difference between the maximum value corresponding to the peak of the amplitude of the loss function and the minimum value corresponding to the valley of the amplitude of the loss function by 2.

For example, the processor 110 may obtain the heading confidence based on the median value and the difference value.

For example, the processor 110 may determine a result value, which is obtained by dividing the difference value by the median value, as the heading confidence for the first virtual box.

In an example, the processor 110 may obtain an angle for correcting or adjusting a first heading direction of the first virtual box based on the heading confidence for the first virtual box.

For example, the processor 110 may apply confidence to the first heading direction of the first virtual box. For example, the processor 110 may obtain an angle for correcting or adjusting the first heading direction of the first virtual box based on applying the heading confidence to the first heading direction of the first virtual box.

For example, the processor 110 may apply a correction coefficient to the first heading direction of the first virtual box. The correction coefficient is obtained by applying an exponent to heading confidence (e.g., Xn, where “X” is a value of the heading confidence and “n” is the exponent, indicating how many times X is multiplied by itself). For example, the processor 110 may obtain an angle for correcting or adjusting the first heading direction of the first virtual box based on applying the correction coefficient to the first heading direction of the first virtual box.

For example, the processor 110 may determine an exponent based on at least one of the heading confidence for the first virtual box, a size of the first virtual box, a distance between the external object and the vehicle, or the number of points included in the point cloud, or any combination thereof.

The above-described content may be summarized as Equation 1 below.

$${θ}_{guided} = {θ}_{origin} * {C}^{γ} \qquad [ Equation 1 ]$$

In Equation 1, θ_{origin} may include an angle expressing the first heading direction of the first virtual box. In Equation 1, C may include the heading confidence for the first virtual box. In Equation 1, γ may include the exponent described above. In Equation 1, θ_{guided} may include an angle for correcting or adjusting the first heading direction of the first virtual box.

For example, at least one of θ_{origin}, or θ_{guided}, or any combination thereof may include an angle formed between an x-axis in the vehicle coordinate system centered on the vehicle and the heading direction of the virtual box. For example, the vehicle coordinate system may include the x-axis facing the traveling direction of the vehicle, a transverse axis (e.g., a y-axis) perpendicular to the traveling direction of the vehicle and perpendicular to the side of the vehicle, and a vertical axis (e.g., a z-axis) perpendicular to the traveling direction of the vehicle and perpendicular to the floor surface of the vehicle, and may include an origin corresponding to the front center of the vehicle.

In an example, the processor 110 may output a second virtual box obtained by correcting or adjusting the first virtual box based on the angle for correcting or adjusting the first heading direction of the first virtual box.

For example, the processor 110 may identify or determine the size of the first virtual box. For example, the processor 110 may identify or determine at least one of a width of the first virtual box, a length of the first virtual box, or a height of the first virtual box, or any combination thereof.

For example, the processor 110 may determine whether the width of the first virtual box is smaller than a first length (e.g., about 1 meter (m)) and the length of the first virtual box is smaller than a second length (e.g., about 1.35 m). For example, the processor 110 may generate the second virtual box obtained by correcting or adjusting the first virtual box based on the width of the first virtual box being smaller than the first length and the length of the first virtual box being smaller than the second length.

For example, the processor 110 may generate the second virtual box with a second heading direction indicating an angle difference for correcting or adjusting the first heading direction of the first virtual box based on the x-axis of the vehicle coordinate system centered on the vehicle.

For example, the processor 110 may generate the second virtual box obtained by correcting or adjusting the first virtual box based on a maximum value of the z-axis direction (e.g., a vertical axis direction of an object), a minimum value of the z-axis direction, and an angle for correcting or adjusting the first heading direction of the first virtual box among coordinate values of points included in the point cloud.

As described above, the processor 110 of the vehicle control apparatus 100 according to an example may generate the second virtual box with the second heading direction different from the first heading direction by correcting or adjusting the first heading direction of the first virtual box. The processor 110 may increase the driving stability of the vehicle by box with the second heading outputting a second virtual direction.

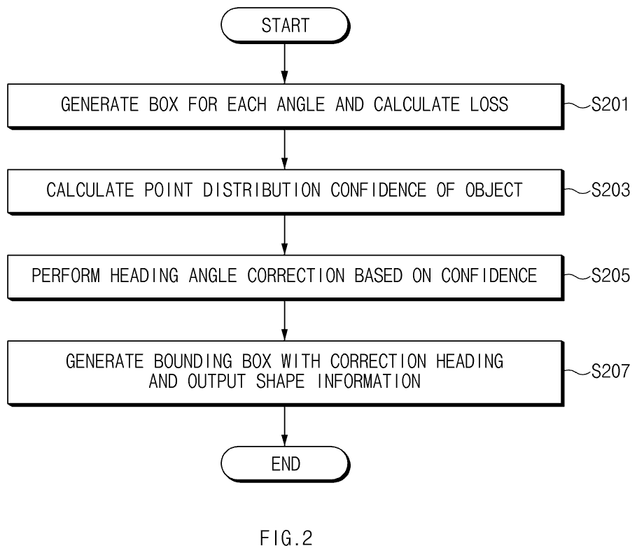

FIG. 2 shows an example of a flowchart associated with a vehicle control method, according to an example of the present disclosure.

Hereinafter, it is assumed that the vehicle control apparatus 100 of FIG. 1 performs the process of FIG. 2. In addition, in a description of FIG. 2, it may be understood that an operation described as being performed by an apparatus is controlled by the processor 110 of the vehicle control apparatus 100.

At least one of operations of FIG. 2 may be performed by the vehicle control apparatus 100 of FIG. 1. At least one of operations of FIG. 2 may be performed by the processor 110 of FIG. 1. Each of the operations in FIG. 2 may be performed sequentially, but is not necessarily sequentially performed. For example, the order of operations may be changed, and at least two operations may be performed in parallel. One, some, or all operations of FIG. 2, or portions thereof, may be performed by one or more other circuits. One or some, operations of FIG. 2 may be omitted, performed in other orders, and/or otherwise modified, and/or one or more additional steps may be added.

Referring to FIG. 2, in S201, the vehicle control method according to an example may include an operation of generating a box for each angle and calculating or determining loss.

For example, the vehicle control method may include an operation of generating a plurality of virtual boxes based on various angles generated based on a reference point of a point cloud obtained through a LiDAR.

For example, the vehicle control method may include an operation of determining a reference point in an area including a point cloud and generating a plurality of virtual boxes respectively facing the corresponding angles based on angles facing various directions around the reference point.

For example, the vehicle control method may include an operation of calculating or determining the loss of a box for each angle. For example, the loss may include the loss function described in FIG. 1. For example, the vehicle control method may include an operation of calculating or determining the loss at each angle. The vehicle control method may include an operation of obtaining a graph representing the loss based on calculating or determining the loss.

In S203, the vehicle control method according to an example may include an operation of calculating or determining the point distribution confidence of an object.

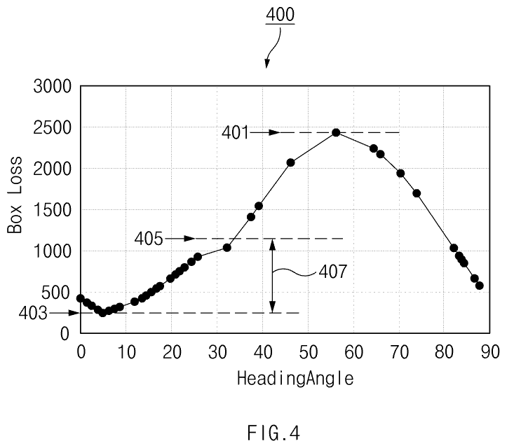

For example, the vehicle control method may include an operation of showing a heading angle-specific loss distribution of a box on a graph. For example, the vehicle control method may include an operation of obtaining a distribution with a period of approximately 90 degrees. The graph showing the loss distribution is described later in FIG. 4.

For example, the vehicle control method may include an operation of obtaining point distribution confidence of an object based on a loss distribution. The point distribution confidence of an object may include the heading confidence described in FIG. 1. Details on obtaining the point distribution confidence of an object based on the loss distribution will be described later in FIG. 4.

In S205, the vehicle control method according to an example may include an operation of performing heading angle correction based on confidence.

For example, the vehicle control method may include an operation of correcting or adjusting a virtual box with low confidence. For example, the vehicle control method may include an operation of correcting or adjusting the virtual box with confidence less than a threshold value.

For example, the vehicle control method may include an operation of identifying or determining a virtual box that needs to correct a heading angle. For example, the vehicle control method may include an operation of correcting or adjusting the virtual box with low confidence that may use the correction of the heading angle.

For example, the virtual box with low confidence may include at least one of a virtual box corresponding to an external object where occlusion occurs, a virtual box corresponding to a static object with an irregular shape including a bush, a virtual box corresponding to a specially shaped vehicle with a complex shape, a virtual box corresponding to a specially shaped vehicle with a U-shape, or a virtual box corresponding to a pedestrian, or any combination thereof.

For example, the vehicle control method may include an operation of correcting or adjusting a virtual box whose size is less than a designated size. For example, the vehicle control method may include an operation of correcting or adjusting a virtual box of which the width is smaller than about 1 m and of which the length is smaller than about 1.35 m.

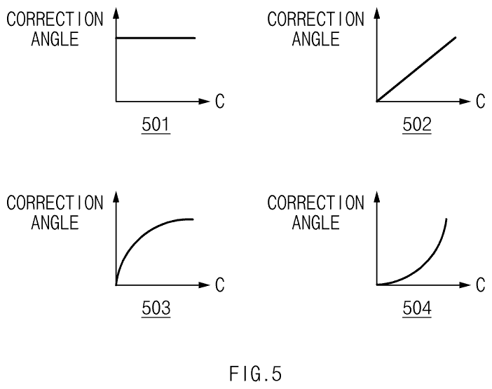

For example, the vehicle control method may include an operation of generating a new virtual box, which is obtained by correcting or adjusting a heading direction, by applying a guide coefficient to the heading direction. The guide coefficient may include the coefficient included in Equation 1 described in FIG. 1. The description associated with the guide coefficient is given later in FIG. 5.

For example, the vehicle control method may include an operation of adjusting correction strength by adjusting the guide coefficient based on confidence. For example, the vehicle control method may include an operation of adjusting the correction strength by adjusting the guide coefficient based on the size of the virtual box. For example, the vehicle control method may include an operation of adjusting the correction strength by adjusting the guide coefficient based on the distance between the vehicle and the external object. For example, the vehicle control method may include an operation of adjusting strength by adjusting the guide coefficient based on the number of points included in the virtual box.

In S207, the vehicle control method according to an example may include an operation of generating a bounding box with correction heading and outputting shape information.

For example, the vehicle control method may include an operation of generating a bounding box with the correction heading by using a ‘z’ value of the points included in the point cloud. For example, the bounding box may include a virtual box represented in three-dimensional space. For example, the bounding box may include an operation of outputting shape information based on extracting the shape information including at least one of eight points respectively indicating vertexes, a box point index, a width, a length, a height, a heading direction, or an area, or any combination thereof.

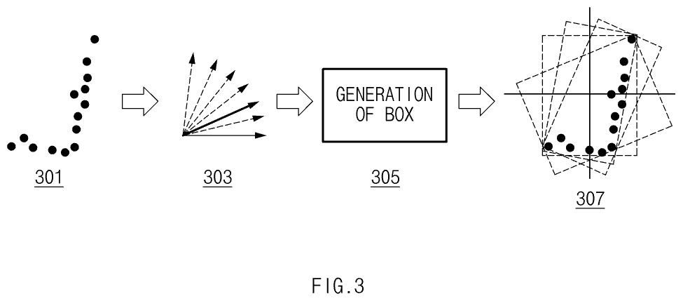

FIG. 3 shows an example of generating a virtual box, in an example of the present disclosure.

Referring to FIG. 3, a processor (e.g., the processor 110 of FIG. 1) of a vehicle control apparatus (e.g., the vehicle control apparatus 100 of FIG. 1) according to an example may obtain a point cloud 301 through a LiDAR (e.g., the LiDAR 120 in FIG. 1).

In an example, the processor may identify or determine a reference point in the point cloud 301. For example, the processor may determine various angles 303 (or various directions) based on the reference point of the point cloud 301.

For example, the processor may generate a plurality of virtual boxes corresponding to each angle, based on the various angles 303.

For example, the processor may generate virtual boxes 307 with heading directions according to the various angles 303 by using a box generation algorithm 305.

For example, the box generation algorithm 305 may include an algorithm that generates a bounding box by using the input angle.

For example, the processor may generate at least one of a first virtual box, or a second virtual box, or any combination thereof described in FIG. 1 by using the box generation algorithm 305.

FIG. 4 shows an example of obtaining an angle for correcting or adjusting a virtual box by using a loss function, in an example of the present disclosure.

Referring to FIG. 4, a processor (e.g., the processor 110 in FIG. 1) of a vehicle control apparatus (e.g., the vehicle control apparatus 100 in FIG. 1) according to an example may obtain a loss function 400 by applying various angles to a point cloud.

For example, the processor may identify or determine a maximum value 401 corresponding to the peak amplitude of the loss function 400. The processor may identify or determine a minimum value 403 corresponding to the valley of the amplitude of the loss function 400.

For example, the processor may obtain a median value 405 between the maximum value 401 and the minimum value 403. For example, the processor may obtain the median value 405 by dividing the sum of the maximum value 401 and the minimum value 403 by 2. For example, the median value 405 may be substantially the same as the absolute value of amplitude 407.

For example, the processor may obtain a difference value by dividing a difference between the maximum value 401 and the minimum value 403 by 2.

For example, the processor may obtain heading confidence by using the median value 405 and the difference value. For example, the heading confidence may be obtained by using Equation 2 below.

$$Heading Confidence ( C ) = \frac{A}{{L}_{median}} = \frac{( {L}_{max} - {L}_{min} )}{( {L}_{max} + {L}_{min} )} \qquad [ Equation 2 ]$$

For example, in Equation 2, L_{median} may include the median value 405. For example, A may include the difference value. For example, Lₘₐₓ may include the maximum value 401. For example, Lₘᵢₙ may include the minimum value of 403. For example, Heading Confidence (C) may include heading confidence.

The case where the heading confidence is 0 may include the case where there is no amplitude and the confidence where the same loss is output at all angles is lowest. The case where the heading confidence is 1 may include the case where there is an angle where the minimum value 403 is 0 and the confidence is highest.

FIG. 5 shows an example associated with an angle for correcting or adjusting a heading direction of a first virtual box, in an example of the present disclosure.

Referring to FIG. 5, a processor (e.g., the processor 110 of FIG. 1) of a vehicle control apparatus (e.g., the vehicle control apparatus 100 of FIG. 1) according to an example may obtain a correction angle.

For example, the correction angle may be obtained by applying a guide coefficient to heading confidence C in FIG. 5. Examples 501, 502, 503, and 504 in FIG. 5 may include examples of correction angles according to changes in a guide coefficient.

For example, the first example 501 may mean the correction angle according to heading confidence if the guide coefficient is 0. For example, the processor may obtain the same correction angle even though the heading confidence varies if the guide coefficient is 0.

For example, the second example 502 may mean the correction angle according to the heading confidence if the guide coefficient is 1. For example, the processor may obtain the correction angle, which increases linearly as the heading confidence increases if the guide coefficient is 1.

For example, the third example 503 may mean the correction angle according to the heading confidence if the guide coefficient exceeds 0 and is smaller than 1. For example, the processor may obtain the correction angle that increases logarithmically as the heading confidence increases if the guide coefficient exceeds 0 and is smaller than 1.

For example, the fourth example 504 may mean the correction angle according to the heading confidence if the guide coefficient exceeds 1. For example, the processor may obtain the correction angle that increases exponentially as the heading confidence increases or decreases if the guide coefficient exceeds 1.

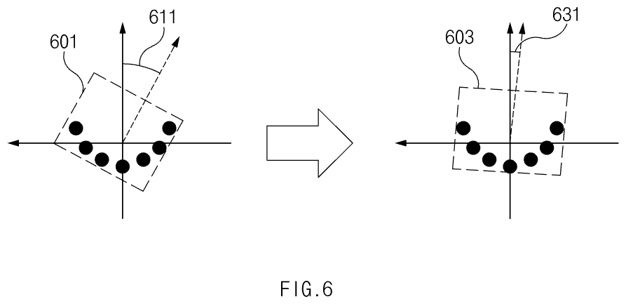

FIG. 6 shows an example of generating a second virtual box by correcting or adjusting a heading direction of a first virtual box, in an example of the present disclosure.

Referring to FIG. 6, a processor (e.g., the processor 110 in FIG. 1) of a vehicle control apparatus (e.g., the vehicle control apparatus 100 of FIG. 1) according to an example may correct a first virtual box 601 to a second virtual box 603.

For example, the processor may obtain a first angle 611 between a first heading direction of the first virtual box 601 and a longitudinal axis (e.g., an x-axis) of a vehicle coordinate system.

For example, the processor may obtain a second angle 631 by applying a coefficient to the first angle 611. For example, the processor may obtain the second angle 631 based on Equation 1 described in FIG. 1.

For example, the first angle 611 and/or the second angle 631 may refer to an angle formed between the x-axis of the vehicle coordinate system and a heading direction.

For example, the processor may input a point cloud and the second angle into a box generation algorithm based on obtaining the second angle 631. The box generation algorithm may include the box generation algorithm described in FIG. 3.

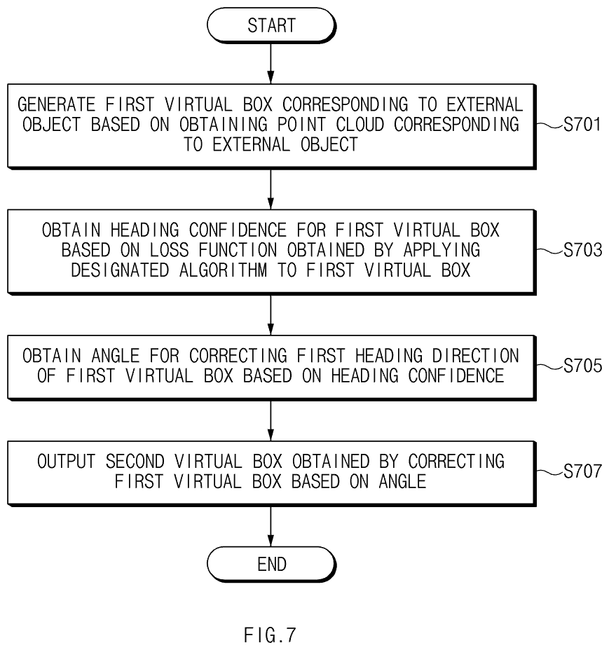

FIG. 7 shows an example of a flowchart associated with a vehicle control method, according to an example of the present disclosure.

Hereinafter, it is assumed that the vehicle control apparatus 100 of FIG. 1 performs the process of FIG. 7. In addition, in a description of FIG. 7, it may be understood that an operation described as being performed by an apparatus is controlled by the processor 110 of the vehicle control apparatus 100.

At least one of operations of FIG. 7 may be performed by the vehicle control apparatus 100 of FIG. 1. At least one of operations of FIG. 7 may be performed by the processor 110 of FIG. 1. Each of the operations in FIG. 7 may be performed sequentially, but is not necessarily sequentially performed. For example, the order of operations may be changed, and at least two operations may be performed in parallel. One, some, or all operations of FIG. 7, or portions thereof, may be performed by one or more other circuits. One or some, operations of FIG. 7 may be omitted, performed in other orders, and/or otherwise modified, and/or one or more additional steps may be added.

Referring to FIG. 7, in S701, a vehicle control method according to an example may include an operation of generating a first virtual box corresponding to an external object based on obtaining the point cloud corresponding to the external object.

In S703, a vehicle control method according to an example may include an operation of obtaining heading confidence for a first virtual box based on a loss function obtained by applying a designated algorithm to the first virtual box.

For examples of the designated algorithm, a neural network (NN) may be used to process data from a virtual box, where the loss function represents the difference between predicted and actual heading directions, and the neural network may adjust its parameters to reduce this error. For another example, Kalman Filter may be used to estimate a state of a moving object by integrating sensor data, thereby reducing the error between predicted and observed vehicle heading data. A Support Vector Machine (SVM) may be also used to classify or regress data related to the vehicle's heading, with the loss function indicating classification or regression errors. For another example, a gradient descent algorithm may be used to improve a machine learning model by iteratively reducing the loss function, adjusting the model's parameters (such as heading direction) based on the data from a virtual box. A reinforcement learning (RL) approach, (e.g., Q-learning or Proximal Policy Optimization (PPO), etc.), may also be used, allowing the vehicle to learn optimal heading decisions by interacting with the environment, with the loss function representing the difference between expected rewards and actual outcomes.

For example, the vehicle control method may include an operation of obtaining the heading confidence based on a maximum value corresponding to a peak of the loss function and a minimum value corresponding to a valley of the loss function.

For example, the vehicle control method may include an operation of obtaining the heading confidence based on a median value, which obtained by dividing a sum of the maximum value and the minimum value by 2, and a difference value, which is obtained by dividing a difference between the maximum value and the minimum value by 2.

For example, the vehicle control method may include an operation of determining a result value, which is obtained by dividing the difference value by the median value, as the heading confidence.

In S705, a vehicle control method according to an example may include an operation of obtaining an angle for correcting or adjusting a first heading direction of the first virtual box based on the heading confidence.

For example, the vehicle control method may include an operation of obtaining the angle for correcting or adjusting the first heading direction based on applying the heading confidence to the first heading direction of the first virtual box.

For example, the vehicle control method may include an operation of obtaining the angle for correcting or adjusting the first heading direction based on applying a correction coefficient, which is obtained by applying an exponent to the heading confidence, to the first heading direction of the first virtual box.

For example, the vehicle control method may include an operation of determining the exponent based on at least one of the heading confidence, a size of the first virtual box, a distance between the external object and a vehicle, or the number of points included in the point cloud, or any combination thereof.

In S707, a vehicle control method according to an example may include an operation of outputting a second virtual box obtained by correcting or adjusting the first virtual box based on the angle.

For example, the vehicle control method may include an operation of generating the second virtual box obtained by correcting or adjusting the first virtual box based on a width of the first virtual box being smaller than a first length and the length of the first virtual box being smaller than a second length.

For example, the vehicle control method may include an operation of generating the second virtual box with a second heading direction indicating a difference in the angle based on an x-axis of a vehicle coordinate system centered on a vehicle.

For example, the vehicle control method may include an operation of generating the second virtual box obtained by correcting or adjusting the first virtual box based on a maximum value of the z-axis direction, a minimum value of the z-axis direction, and an angle for correcting or adjusting the first heading direction among coordinate values of points included in the point cloud.

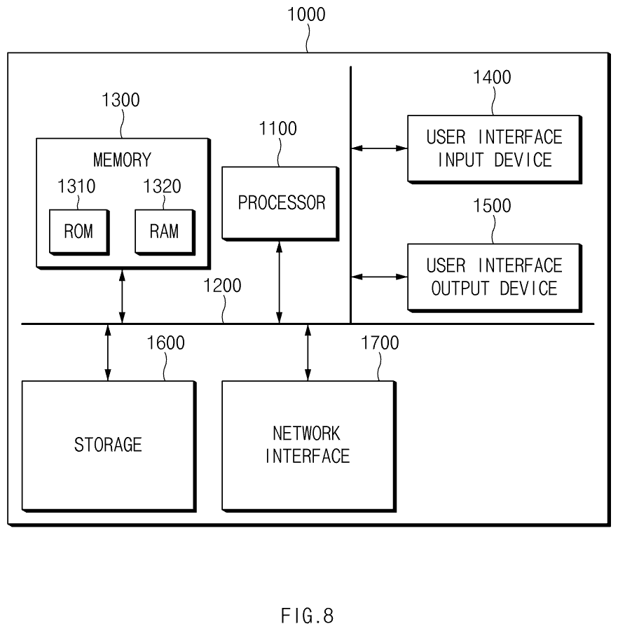

FIG. 8 shows an example of a computing system associated with a vehicle control apparatus or vehicle control method, according to an example of the present disclosure.

Referring to FIG. 8, a computing system 1000 may include at least one processor 1100, a memory 1300, a user interface input device 1400, a user interface output device 1500, storage 1600, and a network interface 1700, which are connected with each other via a bus 1200. For examples, the user interface input device 1400 may comprise keyboards, mice, and touchscreens. Other examples are styluses for drawing, trackpads for navigation, and microphones for voice commands. More specialized input devices comprise game controllers, joysticks, trackballs, or digital pens. For examples, the user interface output device 1500 may comprise monitors and displays for visual output, speakers and headphones for audio output, printers for producing physical documents, or haptic devices that provide tactile feedback, such as vibrations or pressure.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the examples of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, the examples of the present disclosure are provided to explain the spirit and scope of the present disclosure, but not to limit them, so that the spirit and scope of the present disclosure is not limited by the examples. The scope of the present disclosure should be construed on the basis of the accompanying claims, and all the technical ideas within the scope equivalent to the claims should be included in the scope of the present disclosure.

The above description is merely an example of the technical idea of the present disclosure, and various modifications and modifications may be made by one skilled in the art without departing from the characteristic of the present disclosure.

Accordingly, examples of the present disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

The present technology may correct a heading direction of a virtual box corresponding to an external object.

Moreover, the present technology may improve the driving stability of a driving assistance mode and/or an autonomous driving mode of the vehicle by correcting or adjusting the heading direction of the virtual box corresponding to the external object.

Furthermore, the present technology may improve the driving stability of a driving assistance mode and/or an autonomous driving mode of the vehicle by accurately outputting the heading direction of the virtual box corresponding to the external object.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., features of the second virtual box) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of the second virtual box) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of the second virtual box) described herein.

Minimum risk maneuver (MRM) operation(s) may also be controlled, for example, based on one or more features (e.g., features of the second virtual box) described herein. A minimal risk maneuvering operation (e.g., a minimal risk maneuver, a minimum risk maneuver)) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of the second virtual box) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes.

This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc. One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of the second virtual box) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

The present disclosure was made to solve the above-mentioned problems occurring in the prior art while advantages achieved by the prior art are maintained intact.

An example of the present disclosure provides a vehicle control apparatus for correcting or adjusting a heading direction of a virtual box corresponding to an external object, and a method thereof.

An example of the present disclosure provides a vehicle control apparatus for improving the driving stability of a driving assistance mode and/or an autonomous driving mode of the vehicle by correcting or adjusting the heading direction of the virtual box corresponding to the external object, and a method thereof.

An example of the present disclosure provides a vehicle control apparatus for improving the driving stability of a driving assistance mode and/or an autonomous driving mode of the vehicle by accurately outputting the heading direction of the virtual box corresponding to the external object, and a method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus may include a light detection and ranging (LiDAR) and a processor. The processor may generate a first virtual box corresponding to an external object based on obtaining a point cloud corresponding to the external object through the LiDAR, may obtain heading confidence for the first virtual box based on a loss function obtained by applying a designated algorithm to the first virtual box, may obtain an angle for correcting or adjusting a first heading direction of the first virtual box based on the heading confidence, and may output a second virtual box obtained by correcting or adjusting the first virtual box based on the angle.

In an example, the processor may obtain the heading confidence based on a peak of the loss function (e.g., a maximum and a valley of the loss function (e.g., a minimum value).

In an example, the processor may obtain the heading confidence based on a median value, which obtained by dividing a sum of the maximum value and the minimum value by 2, and a difference value, which is obtained by dividing a difference between the maximum value and the minimum value by 2.

In an example, the processor may determine a result value, which is obtained by dividing the difference value by the median value, as the heading confidence.

In an example, the processor may generate a second virtual box obtained by correcting or adjusting the first virtual box based on a width of the first virtual box being smaller than a first length and the length of the first virtual box being smaller than a second length.

In an example, the processor may obtain the angle based on applying the heading confidence to the first heading direction of the first virtual box.

In an example, the processor may obtain the angle based on applying a correction coefficient, which is obtained by applying an exponent to the heading confidence, to the first heading direction of the first virtual box.

In an example, the processor may determine the exponent based on at least one of the heading confidence, a size of the first virtual box, a distance between the external object and a vehicle, or a number of points included in the point cloud, or any combination thereof.

In an example, the processor may generate the second virtual box with a second heading direction indicating a difference in the angle based on an x-axis of a vehicle coordinate system centered on a vehicle.

In an example, the processor may generate the second virtual box obtained by correcting or adjusting the first virtual box based on a maximum value of a z-axis direction, a minimum value of the z-axis direction, and the angle among coordinate values of points included in the point cloud.

According to an example of the present disclosure, a vehicle control method may include generating, by a processor, a first virtual box corresponding to an external object based on obtaining a cluster of points (e.g., a point cloud) corresponding to the external object through a LiDAR, obtaining heading confidence for the first virtual box based on a loss function obtained by applying a designated algorithm to the first virtual box, obtaining an angle for correcting or adjusting a first heading direction of the first virtual box based on the heading confidence, and outputting a second virtual box obtained by correcting or adjusting the first virtual box based on the angle. The cluster of points may be a point cloud.

According to an example, the vehicle control method may include obtaining the heading confidence based on a maximum value corresponding to a peak of the loss function and a minimum value corresponding to a valley of the loss function.

According to an example, the vehicle control method may include obtaining the heading confidence based on a median value, which obtained by dividing a sum of the maximum value and the minimum value by 2, and a difference value, which is obtained by dividing a difference between the maximum value and the minimum value by 2.

According to an example, the vehicle control method may include determining a result value, which is obtained by dividing the difference value by the median value, as the heading confidence.

According to an example, the vehicle control method may include generating a second virtual box obtained by correcting or adjusting the first virtual box based on a width of the first virtual box being smaller than a first length and the length of the first virtual box being smaller than a second length.

According to an example, the vehicle control method may include obtaining the angle based on applying the heading confidence to the first heading direction of the first virtual box.

According to an example, the vehicle control method may include obtaining the angle based on applying a correction coefficient, which is obtained by applying an exponent to the heading confidence, to the first heading direction of the first virtual box.

According to an example, the vehicle control method may include determining the exponent based on at least one of the heading confidence, a size of the first virtual box, a distance between the external object and a vehicle, or a number of points included in the point cloud, or any combination thereof.

According to an example, the vehicle control method may include generating the second virtual box with a second heading direction indicating a difference in the angle based on an x-axis of a vehicle coordinate system centered on a vehicle.

According to an example, the vehicle control method may include generating the second virtual box obtained by correcting or adjusting the first virtual box based on a maximum value of a z-axis direction, a minimum value of the z-axis direction, and the angle among coordinate values of points included in the point cloud.

Besides, a variety of effects directly or indirectly understood through the present disclosure may be provided.

Hereinabove, although the present disclosure was described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling autonomous driving of a vehicle, the apparatus comprising:
a sensor configured to obtain a cluster of points, wherein the cluster of points corresponds to an object; and
a processor configured to:
generate, based on information from the sensor, a first virtual box, wherein the first virtual box corresponds to the object;
obtain, based on a loss function associated with the first virtual box, a heading confidence value for a heading direction of the first virtual box, wherein the loss function is obtained by applying a designated algorithm to the first virtual box, and wherein the loss function represents a degree of accuracy of the designated algorithm for determining the heading direction;
obtain, based on the heading confidence value, an angle value for adjusting the heading direction;
output, based on adjusting the heading direction of the first virtual box, a second virtual box, wherein the heading direction is adjusted based on the angle value;
generate a signal indicating the second virtual box; and
control, based on the signal, autonomous driving of the vehicle.

2. The apparatus of claim 1, wherein the processor is configured to:
obtain, based on a peak of the loss function and a valley of the loss function, the heading confidence value.

3. The apparatus of claim 2, wherein the processor is configured to:
obtain the heading confidence value based on a median value and a difference value, wherein the median value is obtained by dividing a sum of a first value and a second value by two, wherein the first value is associated with the peak of the loss function, wherein the second value is associated with the valley of the loss function, and wherein the difference value is obtained by dividing a difference between the first value and the second value by two.

4. The apparatus of claim 3, wherein the processor is configured to:
determine the heading confidence value by dividing the difference value by the median value.

5. The apparatus of claim 1, wherein the processor is configured to:
generate the second virtual box, wherein the second virtual box is obtained by adjusting the first virtual box based on a width of the first virtual box being smaller than a first length and a length of the first virtual box being smaller than a second length.

6. The apparatus of claim 1, wherein the processor is configured to:
obtain, based on applying the heading confidence value to the heading direction of the first virtual box, the angle value.

7. The apparatus of claim 6, wherein the processor is configured to:
obtain the angle value based on applying a coefficient to the heading direction, wherein the coefficient is obtained by multiplying the heading confidence value by the heading confidence value.

8. The apparatus of claim 7, wherein the processor is configured to determine a number of times of the multiplying based on at least one of:
the heading confidence value,
a size of the first virtual box,
a distance between the object and the vehicle, or a number of points in the cluster of points.

9. The apparatus of claim 1, wherein the processor is configured to generate the second virtual box with a second heading direction, wherein the second heading direction indicates a difference in the angle value based on a longitudinal axis of the vehicle in a vehicle coordinate system, and wherein the vehicle coordinate system is centered on the vehicle.

10. The apparatus of claim 1, wherein the processor is configured to generate the second virtual box, wherein the second virtual box is obtained by adjusting the first virtual box based on a maximum value of a vertical axis direction of the object, a minimum value of the vertical axis direction, and the angle value among coordinate values of points in the cluster of points.

11. A method performed by an apparatus for controlling autonomous driving of a vehicle, the method comprising:
generating, based on information from a sensor, a first virtual box, wherein the first virtual box corresponds to an object, and wherein a cluster of points, corresponding to the object, are obtained by the sensor;
obtaining, based on a loss function associated with the first virtual box, a heading confidence value for a heading direction of the first virtual box, wherein the loss function is obtained by applying a designated algorithm to the first virtual box, and wherein the loss function represents a degree of accuracy of the designated algorithm for determining the heading direction;
obtaining, based on the heading confidence value, an angle value for adjusting the heading direction;
outputting, based on adjusting the heading direction of the first virtual box, a second virtual box, wherein t the heading direction is adjusted based on the angle value;
generating a signal indicating the second virtual box; and
controlling, based on the signal, autonomous driving of the vehicle.

12. The method of claim 11, further comprising:
obtaining, based on a peak of the loss function and a valley of the loss function, the heading confidence value.

13. The method of claim 12, further comprising:
obtaining the heading confidence value based on a median value and a difference value, wherein the median value is obtained by dividing a sum of a first value and a second value by two, wherein the first value is associated with the peak of the loss function, wherein the second value is associated with the valley of the loss function, and wherein the difference value is obtained by dividing a difference between the first value and the second value by two.

14. The method of claim 13, further comprising:
determining the heading confidence value by dividing the difference value by the median value.

15. The method of claim 11, further comprising:
generating the second virtual box, wherein the second virtual box is obtained by adjusting the first virtual box based on a width of the first virtual box being smaller than a first length and a length of the first virtual box being smaller than a second length.

16. The method of claim 11, further comprising:
obtaining, based on applying the heading confidence value to the heading direction of the first virtual box, the angle value.

17. The method of claim 16, further comprising:
obtaining the angle value based on applying a coefficient to the heading direction, wherein the coefficient is obtained by multiplying the heading confidence value by the heading confidence value.

18. The method of claim 17, further comprising:
determining a number of times of the multiplying based on at least one of:
the heading confidence value,
a size of the first virtual box,
a distance between the object and the vehicle, or
a number of points in the cluster of points.

19. The method of claim 11, further comprising:
generating the second virtual box with a second heading direction, wherein the second heading direction indicates a difference in the angle value based on a longitudinal axis of the vehicle in a vehicle coordinate system, and wherein the vehicle coordinate system is centered on the vehicle.

20. The method of claim 11, further comprising:
generating the second virtual box, wherein the second virtual box is obtained by adjusting the first virtual box based on a maximum value of a vertical axis direction of the object, a minimum value of the vertical axis direction, and the angle value among coordinate values of points in the cluster of points.
